(19) United States
(12) Patent Application Publication
(10) Pub. No.: US 2020/0362968 A1
(43) Pub. Date: Nov. 19, 2020

(54) Accordion Style Valve Bonnet and Stem Seal

(71) Applicant: Betts Industries, Inc., Warren, PA (US)

(72) Inventors: David J. Adams, Warren, PA (US); Michael W. Gustafson, Warren, PA (US)

(73) Assignee: Betts Industries, Inc., Warren, PA (US)

(21) Appl. No.: 15/931,246

(22) Filed: May 13, 2020

Related U.S. Application Data
(60) Provisional application No. 62/848,263, filed on May 15, 2019.

(51) Int. Cl. F16J 15/3208; F16J 15/3236

(52) U.S. Cl. CPC F16J 15/3208; F16J 15/3236

(57) ABSTRACT

A seal for a valve stem comprises an upper gland, a lower gland, a packing nut and an accordion type seal that further comprises a seal body that has a plurality of convolutions that are compressible when pressure is applied to the seal body, and an energizer mounted in the interior or exterior root of at least one convolution. The accordion type seal is positioned between the upper gland and the lower gland and the packing nut is threaded onto the valve stem to compress the accordion type seal between the upper gland and the lower gland.

### BACKGROUND

Conventional seals for valves that have a bonnet and stem have problems preventing the escape of pressurized fluid from the valve body. In the cargo tank industry, valves of this type are commonly used, and depending on the type of liquid being loaded/unloaded the prevention of pressurized fluid from escaping is of utmost concern. These seals are often exposed to harsh and volatile fluids, where conventional seals and methods have fallen short. Periodic maintenance is generally required to maintain seal performance which is costly. In some cases, loading/unloading facilities often require specialized testing to hold back pressurized fluid for a timed period before being accepted.

Prior art seals have often consisted of rope packing seals, u-seals, or stacked vee packing seals to name a few. These types of seals have often underperformed when preventing pressurized fluid from escaping. Chemical compatibility also becomes a major factor when dealing with sealability and longevity in volatile service. PTFE materials are often used in the design of these seals which adds another level of complexity. Seals of this material have good chemical resistance when exposed to harsh and volatile fluids over a wide range of temperatures and pressures but can lose resiliency an important sealing property over time. PTFE material will creep and deform over time and lose its ability to seal. Springs are often used to hold the PTFE seals in compression. Rope packing usually consists of a non-asbestos aramid fiber w/PTFE impregnation rope that is cut in pieces and installed in the bonnet of a valve, and a packing gland and packing nut are used to compress the packing around a stem. These seals often weep, are difficult to install, and can take a compression set requiring the packing nut to be tightened in order to maintain the required sealing force. U-cup seals sit in a gland that seals against a bonnet and stem and are orientation specific. These seals cannot be tightened and rely on the pressurized fluid to energize the lips of the u-cup. In some cases, these seals will use springs or energizers to help keep the u-cup in shape, but often weep in low pressure applications. Vee packing seals are also difficult to install because there are multiple pieces, require a spring or Belville to energize, and are orientation specific.

The disadvantages of prior art are overcome by the system and method presented and provided herein.

### SUMMARY

A seal for a valve stem comprises an upper gland, a lower gland, a packing nut and an accordion type seal that further comprises a seal body that has a plurality of convolutions that are compressible when pressure is applied to the seal body, and an energizer mounted in the interior or exterior root of at least one convolution. The accordion type seal is positioned between the upper gland and the lower gland. The packing nut is threaded onto the valve stem to compress the accordion type seal between the upper gland and the lower gland.

In some embodiments, a first energizer is mounted in the interior root of at least one convolution and a second energizer is mounted in the exterior root of at least one convolution. In some embodiments, a plurality of energizers are each mounted to one interior root of a convolution. In some embodiments, a plurality of energizers each mounted one exterior root of a convolution. The energizer could be any of o-rings, coil springs, foams, elastomers, or garter springs.

This invention is capable of embodiments that are different from those shown; thus details of the devices and methods can be changed in various manners without departing from the scope of this invention. Accordingly, the drawings and descriptions are to be regarded as including such equivalent embodiments as to not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawing:

FIG. 1 is a view of a tanker showing the location of a valve mounted to the tanker;

FIG. 2 is a view of a valve into which an accordion style seal is installed;

FIG. 3 is a cross-sectional view of a typical installation of the accordion style seal installed in a valve bonnet or body;

FIG. 4 is an exploded view of the typical installation shown in FIG. 3;

FIG. 5 is a view of an accordion style seal having a plurality of energizers on the exterior convolutions of the seal body;

FIG. 6 is a cross-sectional view of the accordion style seal of FIG. 5;

FIG. 7 is a view of an accordion style seal having a plurality of energizers in the interior convolutions of the seal body;

FIG. 8 is a cross-sectional view of the accordion style seal of FIG. 7;

FIG. 9 is a view of an accordion style seal having a plurality of energizers on both the exterior and the interior convolutions of the seal body; and

FIG. 10 is a cross-sectional view of the accordion style seal of FIG. 9.

### DETAILED DESCRIPTION

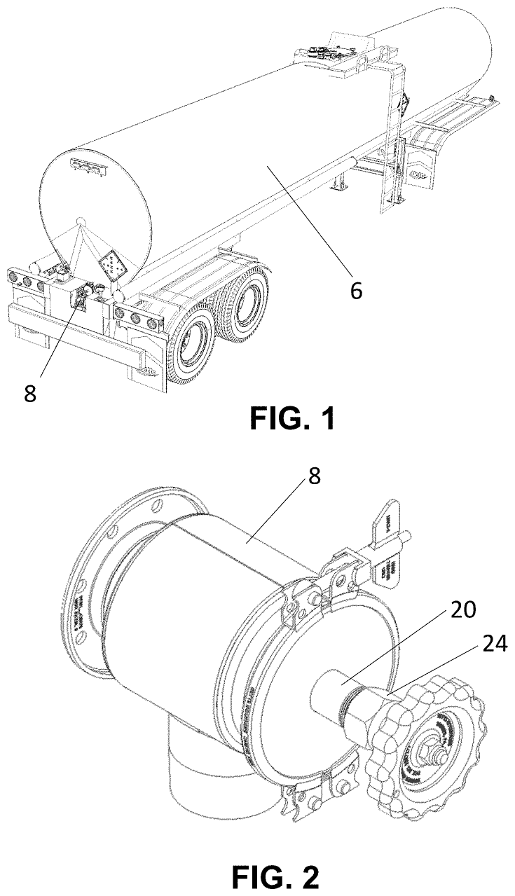

In the cargo tank industry, valves are used in the loading and unloading process and commonly have bonnets and stems to facilitate actuation of the valve. It is of great importance that the joint between the stem and bonnet does not allow the escape of pressurized fluid from the tanker. FIG. 1 shows an example of a tanker 6 onto which a valve 8 is mounted. FIG. 2 shows a close up of the valve 8 of the type discussed herein.

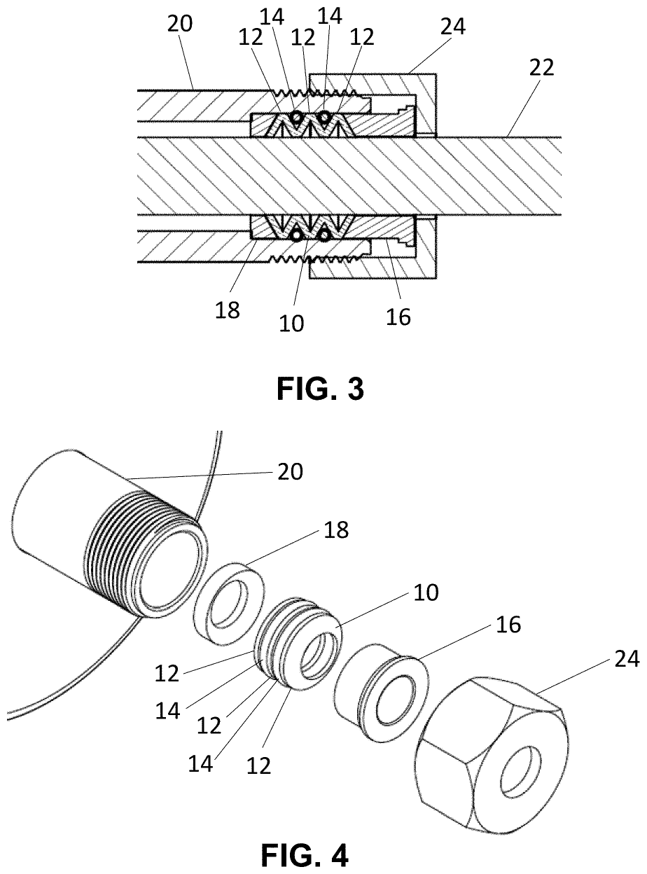

FIG. 3 illustrates a cross sectional view of a typical installation of the accordion style seal 10 installed in the valve bonnet or body 20 of the valve 8. The accordion style seal 10 comprises a seal body 12 that further comprises a plurality of convolutions. At least one energizer 14 is installed between the convolutions of the seal body 12. FIG. 3 depicts a plurality of energizers 14, each mounted in the exterior root of a different convolution in the seal body 12. The accordion style seal 10 is sandwiched between an upper gland 16 and a lower gland 18 inside of a valve bonnet 20 and around a valve stem 22. The sealing force is controlled with the use of a packing nut 24. FIG. 4 illustrates an exploded view of a typical assembly. As best understood by comparing FIG. 3 to FIG. 4, with the valve stem 22 and valve body 20 in place, the lower gland 18 is pushed into the valve bonnet 20 with the valve stem 22 coming up through it (the valve stem 22 is not shown in FIG. 4, but it is understood that it will come up through the valve bonnet 20). Next, the accordion style seal 10 is pushed into the valve body 20. A tool may be used to assist with getting the accordion style seal 10 into the valve body 20. Next, the upper gland 16 is pushed into the valve bonnet 20; finally, the packing nut 24 is threaded onto the valve body 20. The torque required to install the packing nut 24 will vary with the application, and periodic maintenance is necessary to maintain the necessary sealing forces to prevent leakage through the valve bonnet 20. The valve stem 22 may be rotating or sliding.

The energizer 14 may be o-rings, coil springs, foams, elastomers, garter springs, or other device or a combination of such that can fit within the convolutions of the seal body 12. O-rings, as shown in the figures are preferred as they can provide additional sealing between the seal body 12 and the valve bonnet 20. Such multiple-point sealing gives redundancy and a better seal. Unlike some valve seals in the prior art that are typically unidirectional, the accordion style seal 10 provides a fluid seal in both directions.

The accordion style seal 10 with the energizers 14 improves the sealing between the valve bonnet 20 and the valve stem 22. The energizers 14 improve sealing engagement as well as provides additional sealing capability—essentially the energizers 14 push or hold the sealing material, in this case the seal body 12, in position. This accordion style seal 10 greatly reduces the problem of the seal collapsing and compressing thus losing the ability of the seal to be adjusted.

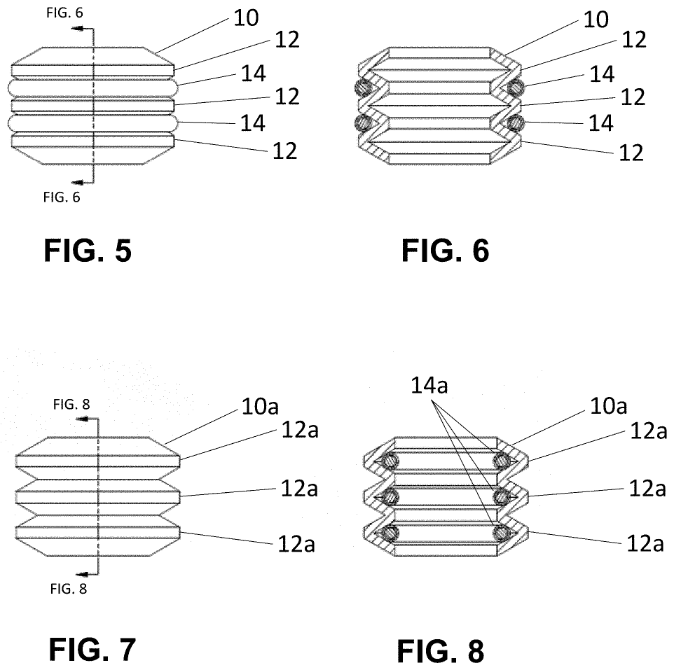

FIGS. 5 and 6 show the accordion style seal 10 used in the assembly of FIGS. 3 and 4. The figures show the accordion style seal 10 with a plurality of energizers 14, each mounted in a different root of the exterior convolutions of the seal body 12. The energizers 14 prevent the accordion style seal 10 from collapsing and losing its seal-ability and keep the accordion style seal 10 engaged with the valve stem 22 and valve bonnet 20 (as shown in FIG. 3). The energizers 14 also offer an additional sealing benefit on the valve stem 22 and valve bonnet 20. Other advantages of the accordion style seal 10 is that it installs in one piece and allows for adjustment for wear or fluctuating tolerances in the valve stem 22 and valve bonnet 20 and is not orientation specific. The use of the accordion style seal 10 is well suited for relatively low pressure and medium pressure applications.

The seal body 12 is preferably made of PTFE Teflon®, and the O-rings 14 are preferably made of FEP Teflon® encapsulated silicon or similar elastomer. The materials chosen provide low friction characteristics and chemical compatibility across a wide range of fluids at different temperatures and concentrations.

It will be understood that the number of convolutions on the seal body 12 could vary with the application. Furthermore, not every convolution needs to have a corresponding energizer 14 and there may be some convolutions on the seal body 12 that do not have any corresponding energizer.

FIGS. 7 and 8 show a variation of accordion style seal 10a in which energizers 14a are mounted in the interior root of the convolutions of the seal body 12a. In this embodiment, a plurality of energizers 14a are each mounted to a different one interior root of a convolution of the seal body 12a. It will be understood that the number of convolutions on the seal body 12a could vary with the application. Furthermore, not every convolution needs to have a corresponding energizer 14a and there may be some convolutions on the seal body 12a that do not have any corresponding energizer.

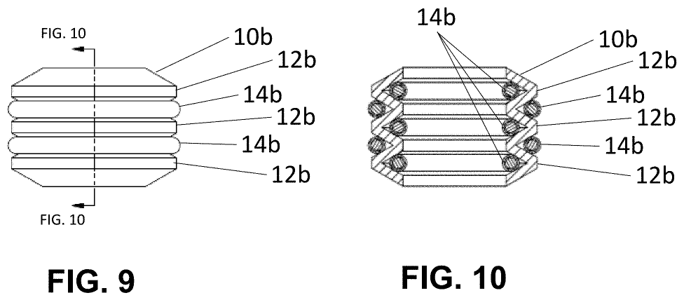

FIGS. 9 and 10 show a variation of accordion style seal 10b in which energizers 14b are mounted in both the interior root and the exterior root of the convolutions of the seal body 12b. In this embodiment, a plurality of energizers 14b are each mounted to a different one interior root and the exterior root of a convolution of the seal body 12b. It will be understood that the number of convolutions on the seal body 12b could vary with the application. Furthermore, not every convolution needs to have a corresponding energizer 14b and there may be some convolutions on the seal body 12b that do not have any corresponding energizer.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. An accordion type seal for a valve stem wherein the accordion type seal comprises:
a seal body that has a plurality of convolutions that are compressible when pressure is applied to said seal body, and
an energizer mounted in the interior or exterior root of at least one said convolution.

2. The accordion type seal of claim 1 comprising a first said energizer mounted in the interior root of at least one said convolution and a second said energizer mounted in the exterior root of at least one said convolution.

3. The accordion type seal of claim 1 comprising a plurality of said energizers each mounted to a different one interior root of a said convolution

4. The accordion type seal of claim 1 comprising a plurality of said energizers each mounted one exterior root of a said convolution.

5. The accordion type seal of claim 1 further comprising said energizer is one of o-rings, coil springs, foams, elastomers, or garter springs.

6. A seal for a valve stem comprising:
an upper gland;
a lower gland;
a packing nut; and
an accordion type seal that further comprises a seal body that has a plurality of convolutions that are compressible when pressure is applied to said seal body, and an energizer mounted in the interior or exterior root of at least one said convolution;
wherein said accordion type seal is positioned between said upper gland and said lower gland and said packing nut is threaded onto said valve stem to compress said accordion type seal between said upper gland and said lower gland.

7. The seal of claim 6 comprising a first said energizer mounted in the interior root of at least one said convolution and a second said energizer mounted in the exterior root of at least one said convolution.

8. The seal of claim 6 comprising a plurality of said energizers each mounted to one interior root of a said convolution

9. The seal of claim 6 comprising a plurality of said energizers each mounted one exterior root of a said convolution.

10. The seal of claim 6 further comprising, said energizer is one of o-rings, coil springs, foams, elastomers, or garter springs.
